(19) United States
(12) Patent Application Publication
(10) Pub. No.: US 2007/0288398 A1
(43) Pub. Date: Dec. 13, 2007

(54) Liquidity Greek letter for options based on commercial real estate indices and property future options

(76) Inventor: Patrick P. Lecomte, Nevers (FR)

Correspondence Address: Mr. Patrick P. Lecomte, 22 rue Paul Vaillant Couturier, Nevers, Nievre, 58000, omitted

(21) Appl. No.: 11/723,053

(22) Filed: Mar. 16, 2007

Related U.S. Application Data
(60) Provisional application No. 60/786,388, filed on Mar. 28, 2006.

(51) Int. Cl. G06Q 40/00

(52) U.S. Cl. 705/36 R

(57) ABSTRACT

To manage risks involved in option positions, traders have developed variables called the ‘Greek letters’ or ‘Greeks’ which capture different dimensions to the risk in an option. These variables which were developed for options linked to assets traded on liquid cash markets (e.g. equity) are appropriate for property options and property futures options as well. Nonetheless, they markedly ignore one fundamental dimension of real estate markets: illiquidity.

Hence, property options (i.e. options based on commercial real estate indices) require additional indicators reflecting the intrinsically illiquid dimension of commercial real estate markets.

This document presents the design of three liquidity Greek letters for options based on commercial real estate indices (property options) and options tied to commercial real estate index based futures contracts (property futures options).

### CROSS REFERENCE TO RELATED APPLICATIONS

This non-provisional application for patent is claiming the benefit of the provisional application No. 60/786,388 filed on Mar. 28, 2006.

### STATEMENT REGARDING FEDERALLY SPONSORED RESEARCH OR DEVELOPMENT

Not applicable.

### REFERENCE TO A SEQUENCE LISTING, A TABLE OR A COMPUTER PROGRAM LISTING COMPACT DISK APPENDIX

Not applicable.

### BACKGROUND OF THE INVENTION

Options based on commercial real estate indices are part of real estate derivatives (e.g. property futures contracts). Real estate derivatives cover both residential and commercial real estate markets.

Options can be traded either in organized exchanges or over-the-counter between private counterparties. They are meant to provide trading opportunities for speculators and non-hedging investors as well as enhanced hedging potential for real estate investors.

### REFERENCES

Hull J. [2003] “Options, Futures and Other Derivatives”, Fifth Edition, Prentice Hall.
Fisher J., D. Gatzlaff, D. Geltner and D. Haurin [2003] “Controlling for the Impact of Variable Liquidity in Commercial Real Estate Price Indices” Real Estate Economics 31, 1.
Lecomte P. and W. McIntosh [2005] “Going Synthetic: The Next Frontier for Property Derivatives” The Institutional Real Estate Letter, Vol. 17, N. 11
Lecomte P. and W. McIntosh [2006] “Designing Property Futures Contracts and Options based on NCREIF Property Indices”, The Journal of Real Estate Portfolio Management, May-August 2006.
Lecomte P., US Patent Pending 20060271388 filed on Nov. 9, 2005 “Derivatives Securities utilizing Commercial Real Estate Indices as Underlying”.
Scholes M. [1999] “Liquidity Options” Risk (November)

### BRIEF SUMMARY OF THE INVENTION

The option template is well suited to address the timing uncertainty inherent to commercial real estate activities, whether development, purchase, or sale. However, because of real estate indices' shortcomings, as well as underlying cash markets' illiquidity, current indicators used by option traders are not sufficient.

This specification presents the design of three liquidity indicators known as ‘liquidity Greek letters’ for options based on commercial real estate indices (property options) and options based on commercial real estate index-based futures contracts (property futures options). These indicators are relevant to traders in property options and property futures options. They are meant to help traders in these options assess risk in their positions.

Potential market for these indicators is very large and includes participants in the real estate industry, fund managers, pension funds and more generally any parties interested in investment management and risk management. Property options and property futures options enable investors to hedge risks involved in real estate assets in an efficient, cost effective though tailor-made manner. The liquidity Greek letters described in this specification will help foster diversification and effective risk management of real estate portfolios and financial asset portfolios alike. They can be used to design instruments aimed at hedging liquidity risk in real assets trading on illiquid cash markets.

### BRIEF DESCRIPTION OF THE SEVERAL VIEWS OF THE DRAWING

Not applicable.

### DETAILED DESCRIPTION OF THE INVENTION

To manage risks involved in option positions, traders have developed variables called the ‘Greek letters’ or ‘Greeks’ which capture different dimensions to the risk in an option. Among those letters are first derivatives that measure rate of change of the option price with respect to:

the price of the underlying asset (delta),

the passage of time with all else remaining equal (theta),

the volatility of the underlying asset (vega),

the interest rate (rho).

In addition, a second partial derivative measures change in the option delta with respect to change in price (gamma).

These variables which were developed for options linked to assets traded on liquid cash markets (e.g. equity) are appropriate for property options and property futures options as well. Nonetheless, they markedly ignore one fundamental dimension of real estate markets: illiquidity.

Hence, options tied to assets trading on illiquid markets such as commercial real estate require additional Greek letters reflecting the intrinsically illiquid dimension of the underlying cash markets.

Liquidity indicators used to construct these Greeks are time to sale in the underlying cash market (for any categories and sub-categories of underlying assets) and transaction volume (for any categories and sub-categories of underlying assets). Any other liquidity indicators can be used to construct liquidity Greek letters as they become available.

Two first derivative ‘liquidity’ Greeks are proposed:
Lefta or the rate of change of the option price with respect to time to sale,
Hydra or the rate of change of the option price with respect to the transaction volume of the underlying cash market.
   Lefta and Hydra respectively stand for money and water creature in Greek. These words which are not letters per se were chosen for their link with the dual concept of liquidity.

In general mathematical form, Lefta (L)=−∂C/∂TS where C is the price of the call option and TS is the time to sale, and Hydra (H)=∂C/∂TV where C is the price of the call option and TV is the transaction volume.

Additionally, a second partial derivative linking real estate markets' two dimensions (i.e. price and transaction) is designed. This Greek called Zeta is equal to the rate of change in the property option delta with respect to change in the underlying cash market's liquidity. In general mathematical form, using the same notations as before with Δ as the call option's delta:

Zeta (Z)=−∂Δ/∂TS based on time to sale,

Or Zeta (Z)=∂Δ/∂TV based on transaction volume.

Hedgers will look for a portfolio of options that is both delta and lefta (or hydra) neutral.

Implicit in the formula for liquidity Greeks is the fact that a real estate asset's cash price is negatively correlated with time to sale and positively correlated with transaction volumes. When time to sale increases, price tends to decrease, resulting in a call property option losing value (and a put property option gaining value). Alternatively, when transaction volume increases, price tends to increase, resulting in a call property option gaining value (and a put property option losing value).

Liquidity Greek letters can be used to design instruments aimed at hedging liquidity risk in commercial real estate such as, but not limited to, options on first liquidity Greeks. These options based on any available liquidity indicators available for the underlying cash markets would trade in parallel to plain-vanilla options.

1- Liquidity Greek letters which encapsulate real estate markets' illiquid dimension complement existing Greek letters in order to give a full picture of risks involved in property options and property futures options.

2- Although initially designed for commercial real estate markets, liquidity Greek letters are applicable to all derivatives instruments tied to ‘real’ assets trading on markets where illiquidity is a risk factor.

3- Liquidity Greek letters can be used to design instruments aimed at hedging liquidity risk in real assets.
